(19) United States
(12) Patent Application Publication
(10) Pub. No.: US 2017/0300836 A1
(43) Pub. Date: Oct. 19, 2017

(54) COMPUTERIZED SYSTEM FOR FACILITATING SALE OF VENUE EVENT TICKETS

(71) Applicant: International Business Machines Corporation, Armonk, NY (US)

(72) Inventors: Brian P. Byrne, Austin, TX (US); Adam R. Holley, Austin, TX (US); Brian T. Lillie, Cedar Park, TX (US); Sushain Pandit, Austin, TX (US)

(21) Appl. No.: 15/132,538

(22) Filed: Apr. 19, 2016

(51) Int. Cl. G06Q 10/02; G06Q 30/02; H04L 29/08

(52) U.S. Cl. CPC G06Q 10/02; H04L 67/12; G06Q 30/0269; G06Q 30/0206; G06Q 30/0253; G06Q 30/0259

(57) ABSTRACT

A system for facilitating sale of venue event tickets involves: a venue interface; a venue offering database containing records of: currently available tickets, past event ticket acceptances, and acceptance history data; a subscriber database containing, for individual subscribers, at least an identification, interests, and contact information; a pricing module which will identify at least one subscriber to whom ticket(s) should be offered, on an urgent basis, at a reduced price determined using an algorithm taking into account at least: subscriber location, time until start for the event, estimated travel time between subscriber location and venue, and content of the acceptance history data; a communications module which will proactively communicate urgent offers to specific subscribers identified by the pricing module; and an evaluation and learning module which employs unsupervised machine learning to analyze acceptance history data and modify the algorithm used by the pricing module.

### FIELD OF THE INVENTION

This disclosure relates generally to computer systems and, more particularly, improvements to computer system technology used in the sale of event tickets.

### BACKGROUND

Event revenues, for ticketed events, generally depend upon maximizing attendance. Lost ticket sales not only result in that lost revenue, but associated revenues for, for example, parking and concession sales (e.g., food, drink, souvenirs, etc.). This is particularly the case for “fixed price” venues where the cost of hosting the event does not change significantly with increased attendance.

Venues employ numerous different marketing approaches to maximize attendance at events including, for example, promotional events and giveaways, discount vouchers, special “package” deals, social media campaigns, etc. designed to spark interest and attendance. However, such approaches typically require greater and broader exposure to even realize a fairly low yield. This is particularly true as the date and time for the event approaches since the most interested/motivated prospective purchasers have typically acted close to the initial offering date/time (for popular special events) or about a week before the event (for normal events), so the prospects for additional ticket sales typically goes down beyond those points because the most interested and motivated prospective purchasers have acted and the rest are likely far less interested and, consequently, motivated.

Still further, in some cases, the venues are in direct competition in the sense that a person cannot be in two places at once, so efforts to make a ticket sale to someone who is already going to a conflicting event are entirely wasted.

In yet other cases, a person may be interested in two or more conflicting events and may be indecisive about which one to choose and, thus, may forego both, particularly as the day/time for the events approach.

In an attempt to improve ticket sales, some computer systems have been created that, in some cases, seek to predict attendance for events in advance based upon various factors and maximize revenues based upon those predictions of demand, or, in other cases, adjust ticket pricing based upon actual demand, in either case, for example, by increasing prices where high demand is likely or exists and lowering prices where low demand is likely or exists. Such systems attempt to find pricing “sweet spots” that are maximized at the intersection of event ticket price and demand.

While such predictive revenue maximization systems can be effective in certain cases, there is still significant need for technological improvements in the operation of such computer systems.

### SUMMARY

One aspect of this disclosure involves a system for facilitating sale of venue event tickets. The system involves at least one computer, including at least one processor and non-transitory storage associated with, and accessible to, the at least one processor.

The system also involves a venue interface, via which venues can identify available tickets for events occurring at the venues within a pre-specified short time prior to an event start time.

The system further involves a venue offering database, stored within the storage and coupled to the venue interface. The venue offering database contains records of currently available tickets, acceptances of tickets for past events previously made available, and acceptance history data relating to details of the acceptances. The details of the acceptances include at least, for each past event, a venue identifier, a date of the past event, a start time of the past event, an acceptance time, and an acceptance price.

The system additionally involves a subscriber database, stored within the storage. The subscriber database contains at least an identification of individual subscribers, interests of the individual subscribers, and contact information for the individual subscribers. The interests were identified by at least one of subscriber specification or analysis of social media presence of the subscriber.

The system further involves a pricing module, stored within the storage and executable by the at least one processor. The pricing module, when executed by the at least one processor, will: access the currently available ticket records in the venue offering database and, for at least one currently available ticket for a specific event, search the subscriber database to identify at least one subscriber to whom the at least one ticket should be offered, on an urgent basis, at a reduced price. The reduced price is determined using an algorithm that takes into account at least: a location of the subscriber, time until a start time for the specific event, estimated travel time between the subscriber's location and venue for the specific event for which the at least one ticket will be offered, and content of the acceptance history data in the venue offering database.

The system also involves a communications module, stored within the storage and executable by the at least one processor. The communications module, when executed by the at least one processor, will proactively communicate urgent offers to specific subscribers identified by the pricing module. The urgent offers will contain an identification, for each urgent offer, of at least the venue, the specific event, the start time and the reduced price. The communications module, when executed by the at least one processor, will also receive a communication when at least one specific subscriber accepts one of the urgent offers by providing payment information, and, in response to receipt of the communication, process the payment information and, when the payment information has been processed, modify at least one record in the venue offering database to reflect that the at least one specific subscriber has accepted one of the urgent offers by updating: a) at least one currently available ticket record, and b) the stored acceptance history data.

Finally, the system involves an evaluation and learning module, stored within the storage and executable by the at least one processor. The evaluation and learning module, when executed by the at least one processor, employs unsupervised machine learning to: i) analyze the acceptance history data, and records in the venue offering database reflecting offers to subscribers that were not accepted to obtain a result, and ii) modify the algorithm used by the pricing module for subscriber selection and pricing based upon the result.

The foregoing and following outlines rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified form, a representation of a system for facilitating sale of venue event tickets; and

FIG. 2 illustrates, in simplified form, an overview flow chart for the operation of one variant of a system as described herein.

### DETAILED DESCRIPTION

This disclosure provides a technical solution to address the aforementioned problems by improving the functioning of computers involved in facilitating sale of venue event tickets, improving the technological field of modeling consumer behavior and ticketing sales using an automated approach that is unconventional in a useful application.

At the outset, certain terms used herein are intended to be defined and construed in the manner set forth, notwithstanding any other definitions that might otherwise be attributed to them, as follows:

The term “event” is specifically intended to mean and encompass sporting events (e.g., football, baseball, soccer, auto racing, golf, fighting sports, etc.), entertainment events (e.g., live concerts, the circus, wrestling shows, ice skating exhibitions and shows, theatre, opera, pageants, movies, festivals, etc.) and other activities for which tickets are sold and, generally, are attended by people possessing a ticket, recognizing that certain events may admit a limited number of attendees who have a status that they do not require a ticket.

The term “venue” is specifically intended to mean any location where an “event” can occur or be held (e.g., stadiums, arenas, concert halls, show halls, stage theatres, movie theatres, etc.).

The term “short time” is specifically intended to mean less than 72 hours prior to a designated start time, and ideally, less than about 48 hours prior, and even more ideally, less than about 24 hours prior, and most ideally, less than about 12 hours prior.

The term “urgent offer” is intended to mean an offer that must be accepted within a very narrow window of time on the order of less than 12 hours and, ideally, even a few hours or less, depending upon the time the offer is made, the type of event and the short time prior to the particular event.

The term “reduced price” is intended to mean any one or more of: a cash discount off of the face value ticket price, a package involving at least two tickets and some other value (e.g., parking, food, drink, souvenir, other perk/benefit, etc.) where the offered price for the package is less than the aggregate price of the tickets alone, or an offer of an equivalent number of tickets for a future event of the same type at no charge (by itself or coupled with a discount on the face value of the current tickets). In general, as a means of quantifying the reduction for offers that include a non-cash benefit, the “reduced price” cash equivalent value should provide an effective discount of at least 50% off the total face value of the ticket(s) being offered. Examples of reduced prices could incorporate, by way of example, if individual has history of past attendance at prior events at the venue, a reduced price can take into account that history (e.g., discount of 50% off tickets for next three events subscriber purchases occurring at that venue), preference for a particular genre of event, could result in reduced price including an offer of an incentive for that event and one or more future events of the same genre at other venues, if the individual has a family of “n” people, a discounted package incorporating “n” tickets and discount for tickets/food/drinks/etc. could be incorporated. In general, the reduced price value should increase as time gets closer to start time of event. Additionally or alternatively, the reduced price will provide the best discount for “urgent offers” requiring “spontaneous” (i.e., almost immediate) action by a recipient (e.g., where the short time prior to event start time is less than some specified value (e.g., 30 minutes) or some calculated value (e.g., where Δt=(time until event start time less travel time) and: 10 minutes<Δt<45 minutes).

The term “processor” is intended to mean an electronic device having the capability to execute program instructions such that each individual processing core in a chip would be a processor, as would a single processing chip.

Finally, “storage” as used herein is intended to mean a form of memory that can store, or stores, data defining structures, data-containing structures, data, and program instructions in a non-transitory manner, for example, such as non-transient solid state memory, a magnetic hard drive, a CD or DVD, a tape drive, or an analogous or equivalent storage medium type would.

In overview, the systems described herein are applicable to event ticket sale circumstances where the following four real-time characteristics are present:
1) Non-zero sum game: The event is not constrained by zero-sum game economics, meaning there's a way for event to make a profit even if a guest gets ticket(s) at a reduced priced because of alternative user behaviors (e.g., buying drink, food, souvenirs, etc). Similarly, even if a “reduced price” is non-monetary (e.g., can bring in a friend for free, or gets free food/drink/upgrade/souvenirs, etc), there's still a way for the event to likely make a profit with respect to that guest through the “cost advantage”;
2) Dynamic pricing: The event ticketing allows alterations to pricing or dynamic adoption of alternate pricing/value models, but the event is not of a type that recurs over an extended time period, and/or is routinely discounted, such that interested guests will normally look for/obtain such discounts (e.g., via Groupon® or other discounts/coupons);
3) Cost advantage: Overall costs associated with the event do not change proportionately with increased attendance (e.g., for a cinema/concert with maximum capacity of 300 guests, hosting at full capacity isn't more expensive (or is only nominally more expensive) than hosting at ½ the maximum capacity. Perhaps a few more persons are needed, for example to collect tickets at entry or for security, but the cost increase goes up in minimal “steps” relative to the significant revenue increase; and
4) Time sensitivity: The event marketing is time-sensitive and constrained within a certain time-window, e.g., a campaign targeted towards bringing more guests for an undersold event using our system will be most effective (relative to conventional approaches that employ conventional marketing) between: a) the time before the event where it is apparent that the event will be meaningfully undersold or, based upon history, a significant upswing in ticket sales that would bring sales to an acceptable level is unlikely, and b) the start time of the event. The time leading up to the event start time is cost sensitive in that there's value in giving increased incentive to guests for attendance as the start time approaches.

With the foregoing in mind, our system for facilitating sale of venue event tickets will now be described, followed by how it operates.

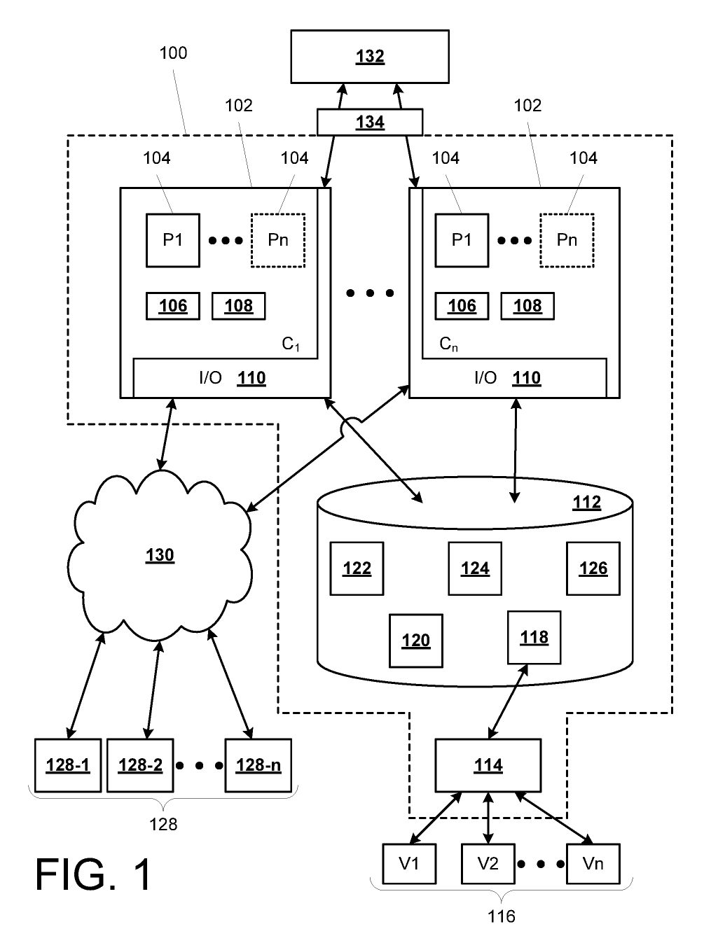

FIG. 1 illustrates, in simplified form, a representation of a system 100 for facilitating sale of venue event tickets.

The system 100 is made up of one or more computers 102 (C₁, . . . , Cₙ) each having at least one, and ideally more, processors 104 (P1, . . . , Pn) as well as associated RAM 106, ROM 108. The computers 102 of the system 100 also include I/O 110, via which they can, for example, send and receive information, be controlled, and communicate with other systems as necessary or desired.

The system 100 also includes storage 102, that is associated with, and accessible to, the processor(s) 104, as well as a venue interface 114 via which venues 116 (V1, V2, . . . , Vn) can identify to the system 100 tickets that are available for events that are occurring at the venues within a pre-specified short time prior to the start times of the particular events.

The storage 112 stores several sub-components of the system. Specifically, the storage 112 includes a venue offering database 118, coupled to the venue interface 114, a subscriber database 120, a pricing module 122, a communications module 124 and an evaluation and learning module 126.

The venue offering database 118 is made up of multiple records that identify currently available tickets, on a venue basis, maintains records of acceptances of tickets for past events that were previously made available via the system 100 including, and other historical data relating to those acceptances, for example, as applicable, including at least some identifier(s) relating to the substance of the event (for example, the event name/movie title, type of event, genre of the event, performer(s)/team(s), etc.), an identifier of the venue where the event occurred, the date of the event, the start time of the event, the time that an urgent offer was accepted (e.g., directly or relative to the start time) and an indication of the price at which the urgent offer was accepted (e.g., as an actual value, a value relative to the face value of the event ticket, etc.).

The subscriber database 120 is made up of records that each contain, on an individual subscriber 128 basis, at least: some subscriber identifier, the subscriber's address/location, interests of each subscriber, and contact information for each subscriber. Additional demographic information may be requested from the subscriber for inclusion in the subscriber database 120, for example, age, size of household, occupation, etc., or, in some cases, that demographic information may be ascertainable from the subscriber's social media or through purchase from entities whose business it is to collect and sell such information. That information forms the basic subscriber profile.

In general, a subscriber profile is initially created when a subscriber is added to the database 120 by agreement (for example, depending upon the particular system 100 implementation, by accessing a website and signing up, downloading/installing an “app” on their smart phone, tablet, smart watch or other device, or even submitting an application on paper) and, depending upon the particular implementation, either directly supplies, or indirectly provides access to, at least one means, and ideally more means, by which they can be contacted in an urgent manner. The subscriber interest information reflected within a subscriber's profile within the subscriber database 120 can be obtained by at least one of two ways. In the first, the subscriber can specify it, for example, in a direct manner, by answering questions or making selections, via an on-line interface and/or on paper, reflective of their interests, or in an indirect manner, by providing access to certain available information, for example, a list of music and/or movies or other information stored on their computer, smart phone, tablet or other device via which they subscribe or which they identify to the system 100. Note the specification can be made at the same time, initially using the same means, as signing up, or at a different time, in some cases, using a different medium than used to sign up. In the second, the subscriber's interests are identified by analysis of the subscriber's social media presence. For example, when the subscriber signs up, they will agree to allow access to at least some of the subscriber's social media related accounts and memberships, for example, Facebook®, LinkedIn®, Twitter®, Google+®, Instagram®, Pinterest®, Tumblr®, TouTube®, Reddit®, Yelp®, MeetUp®, Flickr®, etc. The system 100 will then access those accounts periodically and analyze them for areas of interest, for example, posting about particular subject matter and/or persons, “like(s)” of the posts of others, person(s)/group(s) who the subscriber follows, tags added by the subscriber reflecting interests or attendance at events, groups to which the subscriber belongs/comments, etc. The analysis may take the simple form of recognizing the names of groups/teams, personalities, music genres, specific sports or other activit(y/ies) participation and setting flags in the subscriber database 120 or adding system codes reflective of that identified content.

Typically, even if the particular implementation does not provide for the subscriber giving access to their social media presence, some implementations of the system 100 will nevertheless search for the publicly accessible social media presence of the subscriber and augment any subscriber-supplied interest information stored in the subscriber database with information obtained via that publicly accessible social media presence.

The pricing module 122 is implemented as program instructions that are stored within the storage and executable by the processor(s) 104 such that, when executed, the pricing module 122 will access the venue offering database 118 and search the venue offering database 118 for, and identify, records of currently available tickets. The pricing module 122 will also search the subscriber database 120 for, and identify, at least one subscriber to whom at least one of the currently available tickets should be offered, on an urgent basis, at a reduced price.

The pricing module 122 accomplishes this by matching the events corresponding to the currently available events with the subscriber interests. Ideally, the matching will not merely take into account both, for example, a concert by a country music star with a subscriber having an interest in country music or even that star. Rather, the pricing module 122 can be constructed so that it also takes into account the intensity of that interest by, for example, examining the number of social media “likes” of relevant postings, the number of postings by the subscriber relating to that interest, the specificity of the postings (e.g., mentions of the specific artist/team/event/event type as opposed to mention of in conjunction with other artists/teams/events, and/or mention of specific works by that artist/players/performers/shows, as opposed to mere mention of the artist/team/player/performer/event, etc.), examining the number of different social media places where the subscriber has posted or “liked” subject matter relevant to their interest.

Depending upon the particular implementation, the pricing module may also take into account whether any of the subscriber's social media “friends”/“contacts” are also subscribers and, whether they have indicated that they are going to that event or have similar interests.

Once the pricing module 122 has completed its matching, the pricing module 122 will determine a reduced price for the ticket to be included in an urgent offer to the subscriber. To make that determination, the pricing module will leverage technology used for trip routing that takes into account the location of the subscriber (either the stored address in the subscriber database 120, and/or, where available in real time and based upon the then-current time and event start time, potentially their then-current physical location) in order to determine how far the subscriber is from the event, how long until the start time of the event, an estimate of how long it would take them to get to the event (potentially taking into account differences among various modes of transportation (e.g., public transportation versus driving versus walking (if in the same urban area)), and content of the acceptance history data stored within the venue offering database 118. The travel-related information establishes a level of urgency and likelihood of acceptance. For example, all other things being equal, an offer made three hours before the start of an event to two persons, one who must travel for about an hour to get to the event venue, versus one who can walk or take public transportation (bus, subway, shuttle, light rail, trolley, etc.) to the event venue in less than 30 minutes, is more likely to be accepted by the latter than the former person.

The content of the acceptance history data stored within the venue offering database 118 is useful because it may indicate, for example, past acceptances by that subscriber and the price/timing of their purchase, past acceptances by subscribed “friends”/“contacts” of the subscriber for similar events and the timing of those purchases, large numbers of last-minute purchases at regular price in the normal course, a discount threshold above which those types of tickets remain unsold within the short time period and below which they sell, etc.

That collective information is used to determine, based upon past actions of the subscriber and others, how much of a reduction for that type of ticket/event/day/time will likely result in the subscriber making the purchase.

The communications module 124 receives subscriber identification and reduced pricing information from the pricing module 122 and, using that information, constructs, and proactively communicates, particular urgent offers to specific subscribers 128, via a communications network 130, for example, the internet, a cellular data network, etc. As noted above, these urgent offers are sent within a short time prior to the start of their respective events and, must be accepted within a very narrow window of time. As constructed, each urgent offer will contain an identification of at least, the venue, the specific event, the specific start time and the reduced price. In addition, the communications module 124 receives a communication when a subscriber accepts an urgent offer, with subscriber payment of a form acceptable for the particular implementation (e.g., credit/debit card, PayPal®, bitcoin, etc.) being the trigger for recognizing acceptance of the urgent offer. Upon receipt, the subscriber 128 payment information is processed by forwarding that information to a payment processor 132 appropriate to the particular method of payment via a payment gateway 134. Once the payment has been processed (i.e., verified/approved) the communications module will modify one or more record(s) in the venue offering database 118 to reflect the subscriber's acceptance. This will done by at least updating the appropriate ticket record(s) to reflect the sale of the ticket(s) and the acceptance history data in the non-transient storage with the relevant information. Optionally, additionally, the communications module 124 may update information in the subscriber database 120 so that the purchase can be taken into account in the future by the pricing module 122 if the system is constructed to do so.

The evaluation and learning module 126 employs known unsupervised machine learning techniques, to at least analyze the acceptance history data and the records in the venue offering database 118 for un-accepted urgent offers to learn about, and thereby allow the system 100 to make better urgent offers (i.e., urgent offers that are more likely to be accepted by the corresponding identified subscribers) in terms of, for example, pricing, timing, etc.

Optionally, depending upon the particular system implementation, the evaluation and learning module 126 can take into account information in the subscriber database as well, in order to improve the subscriber selection process, which can further enhance the system operation by providing even better matching of subscribers and urgent offers.

Unsupervised machine learning is a type of machine learning algorithm used to draw inferences from existing datasets. Depending upon the particular implementation of the system 100, this machine learning may involve one of, or some combination of:
a) teaching the system 100 to make decisions on pricing not by giving explicit categorizations of at least the acceptance history data and venue offering database content, but by using some sort of “reward” system to indicate success (in other words, by promoting decisions that brought about a positive result and minimizing decisions that did not yield a positive result); or
b) using clustering techniques, i.e., where the goal is not to maximize a function, but rather to find similarities in the data under the assumption that identified clusters will, due to data dependencies, produce similar future results. An example of the clustering approach is routinely used by websites to recommend, for example, books, movies, other purchases based upon the similar actions of others. Of course, if a clustering approach is used, care must be taken to avoid over-fitting the data.

Ideally, the operation of the evaluation and learning module 126 is fairly continuous in that, as new data is available, it takes that new data into account in its evaluation. The results of the operation of the evaluation and learning module 126 is used to modify the algorithm the pricing module 122 uses for pricing and, in some cases, for subscriber selection through implementation of a closed loop/feedback based system between the evaluation and learning module 126 and pricing module 122. As a result, over time, the system 100 will build models for attendance curves for each venue for given event types/time of year/day of week/subscriber type, location, distance and/or interest(s)/urgent offer pricing/urgent offer timing/etc. and refine those attendance curves.

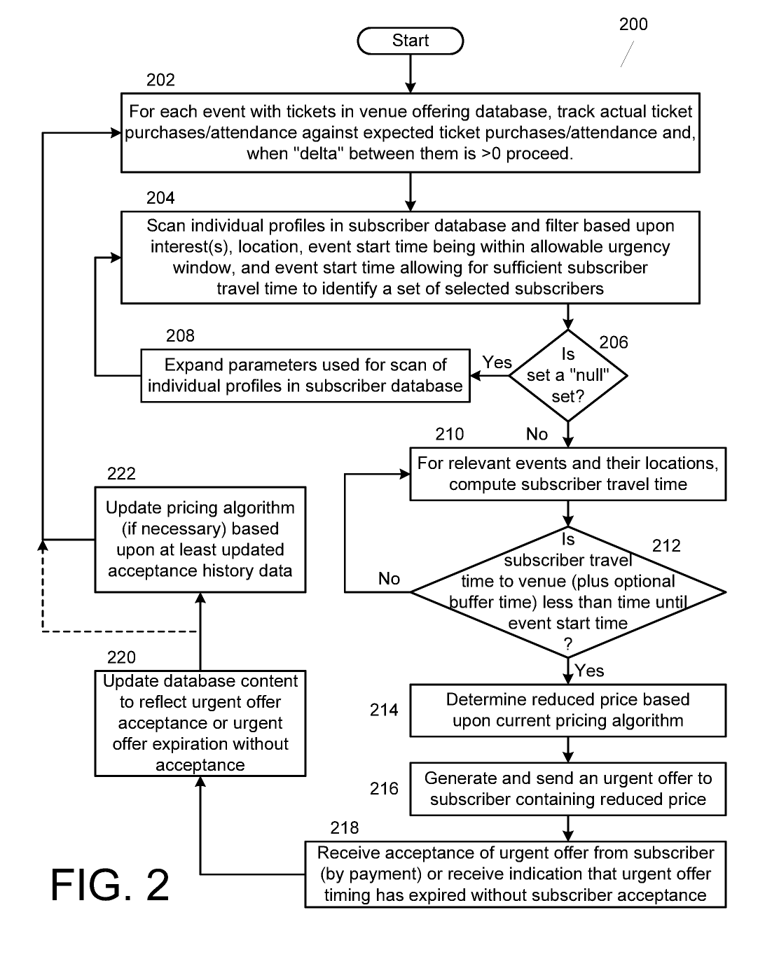

FIG. 2 illustrates, in simplified form, an overview flow chart 200 for the operation of one variant of a system 100 as described herein.

For each instance of an event (e.g., a movie showing, concert, circus, etc.), the system 100 tracks real attendance against expected attendance to compute the difference ‘delta’ and as long as delta >0 for at least one event, the process proceeds (Step 202).

Next, for each vent where delta >0, the system 100 scans through the individual subscriber profiles in the subscriber database and filters them based on interest(s), location, event start time, falling within appropriate urgency and subscriber travel time windows (i.e., relative to event start time), to obtain a resulting set (referred to below as ‘selected subscriber profiles’) (Step 204). If the selected subscriber profiles turns out to be a “null” set (Step 206), the parameters are expanded, for example, by expanding the: interest generality, pre-event start window, and/or travel time window (Step 208), and the scan (Step 204) is repeated with the new parameters.

Then, on an individual event and subscriber basis, for the relevant events and selected subscriber profiles, the subscriber travel times are computed (Step 210) and compared to the time until the event start time (Step 212). If the time until the start time of the event is sooner than the time needed for the particular subscriber to arrive (ideally including some “buffer” time), the system 100 discards that subscriber/event pairing and returns to Step 210. If it is determined in Step 212 there is sufficient time for the subscriber to travel to the event, the system 100 will determine a reduced price based upon the currently in effect pricing algorithm (i.e., as may have been modified by the evaluation and learning module)(Step 214).

Once a reduced price has been determined, the system 100 will generate and send an urgent offer to the subscriber containing the reduced price (Step 216).

At some point thereafter, the system 100 will either receive an acceptance of the urgent offer (by subscriber payment) or, the urgent offer will expire without it having been accepted (Step 218). As a result, the system 100 will update the acceptance history data in the venue offering database 118 (and possibly the subscriber database 120) (Step 220). Based upon the update of the database(s), if a result of the operation of the evaluation and learning module 126 necessitates an update to the pricing algorithm, that update is performed (Step 222), otherwise the updating of the pricing algorithm can be bypassed (indicated by dashed line).

The system 100 will continue to track and make corrections based upon actual sales/attendance versus expected sales/attendance in order to provide further urgent offers or limit/stop urgent offers for particular events at individual venues.

As should now be appreciated, advantageously, through use of a system constructed as described herein, it will be possible to build and adjust attendance curves for each venue and, through the use of the unsupervised machine learning of the evaluation and learning module 126, the algorithm for reduced price determination, over time, can be refined as tickets are sold and urgent offers are accepted or not, thereby facilitating improved sales of event tickets.

Having described and illustrated the principles of this application by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A system for facilitating sale of venue event tickets, the system comprising:
A) at least one computer, including at least one processor and non-transitory storage associated with, and accessible to, the at least one processor;
B) a venue interface via which venues can identify available tickets for events occurring at the venues within a pre-specified short time prior to an event start time;
C) a venue offering database, coupled to the venue interface and stored within the storage, containing records of:
i) currently available tickets,
ii) acceptances of tickets for past events previously made available, and
iii) acceptance history data relating to details of the acceptances, such details including at least, for each past event, a venue identifier, a date of the past event, a start time of the past event, an acceptance time, and an acceptance price;
D) a subscriber database, stored within the storage, the subscriber database containing at least an identification of individual subscribers, interests of the individual subscribers, and contact information for the individual subscribers, the interests having been identified by at least one of subscriber specification or analysis of social media presence of the subscriber;
E) a pricing module, stored within the storage and executable by the at least one processor which, when executed by the at least one processor, will access the currently available ticket records in the venue offering database and, for at least one currently available ticket for a specific event, search the subscriber database to identify at least one subscriber to whom the at least one ticket should be offered, on an urgent basis, at a reduced price, the reduced price being determined using an algorithm that takes into account at least:
i) a location of the subscriber,
ii) time until a start time for the specific event,
iii) estimated travel time between the subscriber's location and venue for the specific event for which the at least one ticket will be offered, and
iv) content of the acceptance history data in the venue offering database;
F) a communications module, stored within the storage and executable by the at least one processor which, when executed by the at least one processor, will:
i) proactively communicate urgent offers to specific subscribers identified by the pricing module, the urgent offers containing an identification, for each urgent offer, of at least the venue, the specific event, the start time and the reduced price, and
ii) receive a communication when at least one specific subscriber accepts one of the urgent offers by providing payment information, and
iii) in response to receipt of the communication, process the payment information and, when the payment information has been processed, modify at least one record in the venue offering database to reflect that the at least one specific subscriber has accepted one of the urgent offers by updating
a) at least one currently available ticket record, and
b) the stored acceptance history data; and
G) an evaluation and learning module, stored within the storage and executable by the at least one processor which, when executed by the at least one processor, employs unsupervised machine learning to:
i) analyze the acceptance history data, and records in the venue offering database reflecting offers to subscribers that were not accepted to obtain a result, and
ii) modify the algorithm used by the pricing module for subscriber selection and pricing based upon the result.
